(19) United States
(12) Patent Application Publication
(10) Pub. No.: US 2003/0211922 A1
(43) Pub. Date: Nov. 13, 2003

(54) Roller for imparting textured impressions

(75) Inventor: Frank Piccolo, Natchitoches, LA (US)

Correspondence Address: HAYNES AND BOONE, LLP, 901 MAIN STREET, SUITE 3100, DALLAS, TX, 75202, US

(73) Assignee: Artcrete, Inc., Natchitoches, LA

(21) Appl. No.: 10/430,490

(22) Filed: May 6, 2003

Related U.S. Application Data
(60) Provisional application No. 60/378,842, filed on May 8, 2002.

(51) Int. Cl. B05C 1/08

(52) U.S. Cl. 492/13

(57) ABSTRACT

A patterned roller is provided for imparting textured impressions into an impressionable surface. The roller includes a handle, an axle assembly attached to the handle, a pair of end caps rotatably disposed on the axle assembly, and an interchangeable sleeve for imparting textured impressions into an impressionable surface.

### CROSS-REFERENCE TO RELATED APPLICATION

This application claims the benefit of the provisional application filed on May 8, 2002 (Serial No. 60/378,842). The provisional application is hereby incorporated by reference for all purposes.

### BACKGROUND

The present invention relates generally to a roller, and more particularly to a roller for imparting textured impressions into impressionable surfaces such as setting concrete.

Concrete is often used to provide a hardened surface for a variety of applications such as in the construction of sidewalks, patios, driveways, and the like. Concrete is typically poured and spread over a predetermined area to harden, or set, over time. Upon setting into a hardened state, the concrete takes a generally nondescript shape or pattern along its surface.

Accordingly, there is a need to provide a roller that can be applied to impart a variety of textured impressions into setting concrete.

### BRIEF DESCRIPTION OF THE DRAWINGS

FIG. 1 is a perspective view of a roller according to the present disclosure.

FIG. 2 is an exploded view of the roller.

FIG. 3 is an interior plan view of an end cap of the roller.

FIG. 4 is a cross-sectional view of the end cap.

FIG. 5 is a perspective view of the roller on concrete.

### DETAILED DESCRIPTION

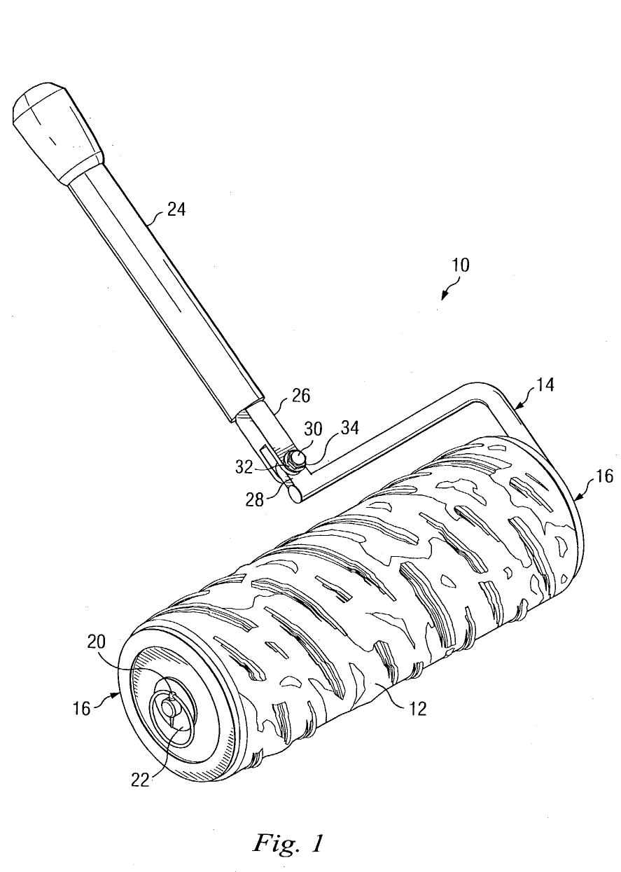

Referring to FIG. 1, the present disclosure relates to a roller, generally given the reference numeral 10, for imparting impressions, such as textured impressions, into impressionable surfaces. For ease of description only, the roller 10 will be described with reference to imparting textured impressions into setting concrete. It is understood that the type of concrete, method of mixing the concrete, and the determination of when the concrete has sufficiently set to use the roller, are all well known to those skilled in the art.

The roller 10 includes a generally cylindrical sleeve 12 for imparting textured impressions into setting concrete. The sleeve 12 contains a textured pattern on its exterior surface to impart textured impressions into setting concrete when rolled across the surface of the setting concrete. For example, the sleeve 12 may contain a textured pattern that replicates leaves, ferns, granite, rock salt, ocean scenes, river bottom, slate, stucco, brick, or any other variety of design. In practice, a variety of sleeves substantially similar to the sleeve 12, albeit each having a different textured pattern, may be created and a user could select between the group of sleeves based upon the desired impression. As will be readily appreciated, the various sleeves 12 are interchangeable on the roller 10.

The present disclosure encompasses many alternative embodiments of the sleeve 12 of varying dimensions, including those having a six inch outer diameter or a twelve inch outer diameter. The sleeve 12 may be longer or shorter depending upon the size of the surface to be decorated.

The sleeve 12 is positioned on an axle assembly 14 via a pair of end caps 16 which provides an axis of rotation for the sleeve. It is understood that for the sake of simplicity, this specification uses the same reference numeral for components that are substantially identical, such as the end caps 16. A pin 20 can be used with a washer 22 to retain the sleeve 12 and the end caps 16 on the axle assembly 14 as is described below. It is understood that a variety of retainers may be used to retain the sleeve 12 and the end caps 16 on the axle assembly.

A handle 24 is operably connected to the sleeve 12 via the axle assembly 14. The handle 24 includes an attachment means 26 for engaging an attachment means 28 of the axle assembly 14. In one embodiment, a conventional bolt 30, used in conjunction with a washer 32 and a nut 34, is disposed through the attachment means 26, 28 of the handle 24 and the axle assembly 14, respectively, thereby securing the handle to the axle assembly. Other conventional attachment means are understood to be contemplated by this disclosure. As can be appreciated, the handle 24 may be of any length or include any extension to adapt the roller 10 for use with a desired surface. For instance, the handle 24 may be used with a conventional bull float handle (not depicted). The attachment means 26,28 enable a variety of different length handles to be used with the sleeve 12.

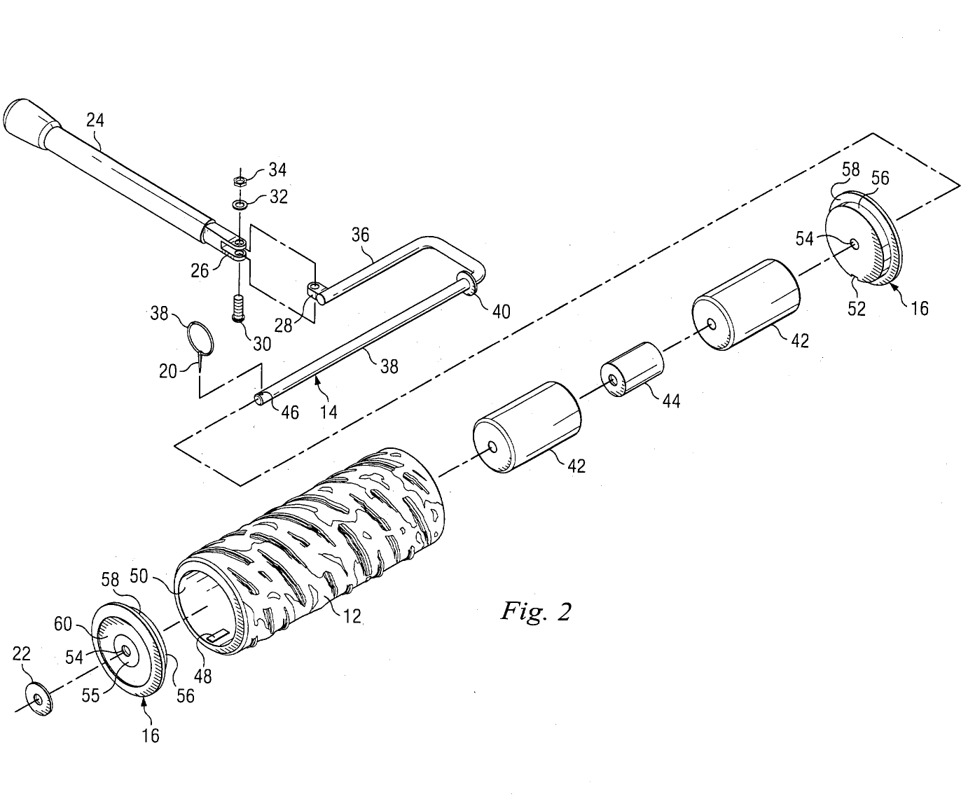

Referring now to FIG. 2, the axle assembly 14 includes a bent shaft portion 36 extending from the attachment means 28 and an axle portion 38 extending from the bent shaft portion 36 to engage the sleeve 12 and end caps 16. It is understood that the numbering of the portions of the axle assembly 14 is for purposes of explanation, and in practice, the portions may comprise a single piece. A stop 40 is disposed on the axle portion 38 for reasons to be explained.

A pair of weights 42 may be disposed on the axle portion 38 to adjust the weight of the roller 10. In one embodiment, the weights 42 are six inch black pipe used for oil production. It can be readily appreciated by those skilled in the art that the weight of the roller 10 affects the depth that the sleeve 12 will sink into the setting concrete. As such, a heavier roller 10 can be used on concrete that has reached a more hardened state of setting while a lighter roller can be used on softer concrete.

A spacer 44 may additionally be disposed on the axle portion 38 to evenly displace the weights 42 along the axle portion 38 to balance the roller 10. It is contemplated that if one weight 42 is used, two spacers 44 (one on either side of the weight) will be used. If two weights 42 are used, only one spacer 44 (disposed between the weights) will be used. If three weights 42 are used, no spacer would be required. Of course, the above examples regarding the number of weights 42 and spacers 44 are dependent on the contemplated length of the weights and spacers relative to the axle portion 38, and the length of the weights and of the spacers are not critical features of the invention. Thus, the examples are in no way intended to limit the means for adjusting the weight of the roller 10.

A hole 46 is formed radially through the distal end of the axle portion 38 for receiving the pin 20, which aids in retaining the sleeve 12 and the end caps 16 as discussed previously. In an alternative embodiment (not depicted), the distal end of the axle portion 38 maybe longitudinally threaded to receive an appropriately sized bolt. Alternatively, both the above-described pin 20 and the above-described bolt can be used.

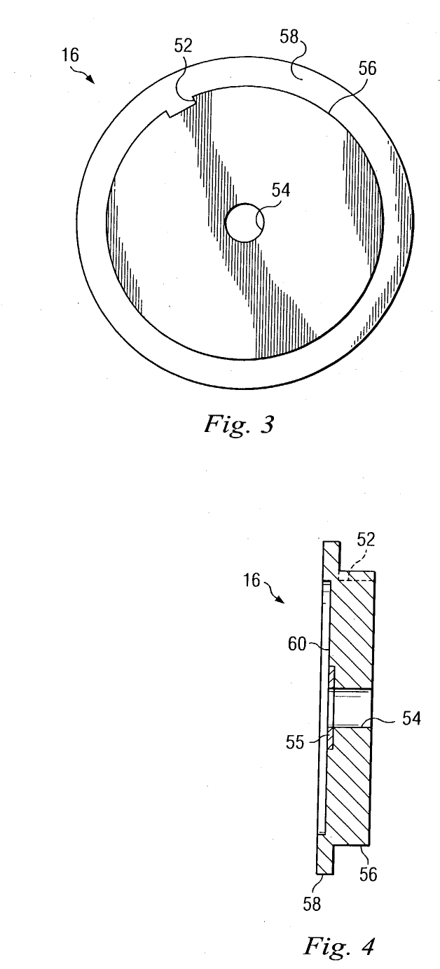

The sleeve 12 includes a pair of tabs 48 (one of which is shown) formed on an interior surface 50 of the sleeve for engaging a groove 52 formed in each of the end caps 16, thereby preventing rotation between the sleeve and the end cap. Referring now also to FIGS. 3 and 4, each end cap 16 includes a hole 54 formed therethrough for receiving the axle portion 38 of the axle assembly 14. The hole 54 is stepped in diameter to accommodate a washer 55, which aids in protecting the end cap 16. A recessed portion 56 of the end cap 16 defines a lip 58 around the circumference of the end cap. The recessed portion 56 is adapted to receive the interior surface 50 of the sleeve 12 in a generally tight fit. The lip 58 has a diameter less than the outer diameter of the sleeve 12 to prevent the lip from contacting the concrete. The exterior face of the end cap 16 is stepped to define a sunken portion 60 of the end cap.

Referring again to FIG. 2, to assemble the roller 10 from the components, one of the end caps 16 is inserted on the axle portion 38 via the hole 54 such that the washer 55 of the end cap engages the stop 40 and the groove 52 is oriented relatively inwards. Next, the sleeve 12 is placed over the axle portion 38 to engage the recessed portion 56 of the end cap 16, thereby engaging the groove 52 with the tab 48 of the sleeve.

Next, a user adds an amount of weight appropriate to the amount of setting of the concrete or the desired depth of impression. For example, one of the weights 42, both weights, or additional weights may be added to the roller 10 with or without the spacer 44 to balance the roller. Alternatively, the user need not add any weight to the roller 10. Thus, the weights 42 provide adjustability for specific conditions. The other end cap 16 is then placed on the axle portion 38 via the hole 54 such that the recessed portion 56 of the end cap 16 engages the sleeve 12 as previously described and the groove 52 engages the tab 48 of the sleeve. The pin 20 and the washer 22 are then used to retain the components on the axle portion 38.

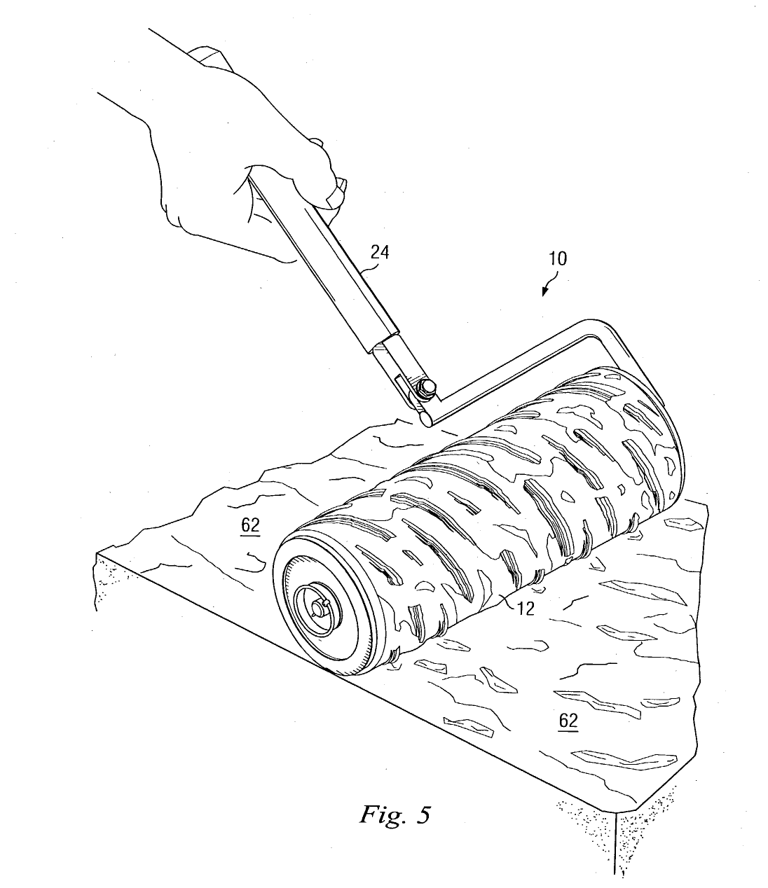

In operation, the roller 10 is assembled as described above, having the sleeve 12 selected from those of differing textured patterns based upon the desired impression, and a weight adjusted to the specific concrete to be impressed. The appropriately sized handle 24 is attached to the axle assembly 14 so that the sleeve 12 can reach over the entire surface to be decorated. The roller 10 is then rolled across setting concrete to impart a design to the concrete surface, an example of which is shown in FIG. 5 and denoted generally by reference numeral 62.

As can be appreciated, the interchangeability of sleeves substantially similar to the sleeve 12, albeit having varied textured patterns, provides the user with a number of options for imparting textured impressions into setting concrete without having to interchange the entire roller 10. Thus, the roller 10 enjoys the advantage of providing an apparatus for decorating setting concrete while employing an easily interchangeable sleeve 12 to allow for the application of various designs.

Although only a few exemplary embodiments of this invention have been described in detail above, those skilled in the art will readily appreciate that many modifications are possible in the exemplary embodiments without materially departing from the novel teachings and advantages of this invention. For instance, although the roller 10 was described with reference to use with setting concrete, it is understood that the roller could be applied to a variety of other impressionable surfaces. In another embodiment, a conventional rubber band may be placed around the outside of the sleeve 12 to impart the image of a saw cut into the impressionable surface. Different widths and profiles of various rubber bands will create different saw cut designs. Therefore, the foregoing disclosure is not intended to limit application of the roller 10 to setting concrete. Accordingly, all such modifications are intended to be included within the scope of this invention as defined in the following claims.

What is claimed is:

1. A roller, comprising:
a handle;
an axle attached to the handle;
a pair of end caps rotatably and removably disposed on the axle; and
a sleeve engaging the end caps and having a textured surface for imparting impressions into an impressionable surface.

2. The roller of claim 1 wherein the impressionable surface is setting concrete.

3. The roller of claim 1 wherein the sleeve is interchangeable with other sleeves.

4. The roller of claim 1 wherein the impressions are textured impressions.

5. The roller of claim 1 further comprising at least one weight removably disposed on the axle for adjusting the weight of the roller.

6. The roller of claim 5 further comprising at least one spacer for evenly spacing the weight on the axle.

7. The roller of claim 1 wherein a groove is formed in each of the end caps for engaging a pair of corresponding tabs formed on the sleeve to prevent rotation between the end caps and the sleeve.

8. The roller of claim 1 wherein the end caps comprise a recessed portion for engaging an interior surface of the sleeve.

9. The roller of claim 1 wherein the diameter of the end caps is less than the diameter of the sleeve.

10. The roller of claim 1 further comprising a rubber band disposed around the sleeve.

11. A roller for imparting textured impressions into setting concrete, comprising:
means for rotatably disposing a first sleeve on an axle assembly, the first sleeve having a first textured pattern; and
means for interchanging the first sleeve with a second sleeve having a second textured pattern.

12. The roller of claim 11 further comprising means for adjusting the weight of the roller.

13. A method for imparting textured impressions into an impressionable surface, comprising:
providing a roller having a first textured sleeve rotatably attached to the roller; and
rolling the roller across the surface such that the sleeve rotatably contacts the surface to impart an impression of the textured sleeve into the surface.

14. The method of claim 13 further comprising interchanging the sleeve with a second textured sleeve, the second texture being different from the first texture.

15. The method of claim 13 further comprising adjusting the weight of the roller by adding weights within the sleeve.
